(19) United States
(12) Patent Application Publication
(10) Pub. No.: US 2017/0260478 A1
(43) Pub. Date: Sep. 14, 2017

(54) MELT DELIVERY SYSTEM

(71) Applicant: S.C. Johnson & Son, Inc., Racine, WI (US)

(72) Inventors: Art Daniels Sutton,, JR., Mount Pleasant, WI (US); John R. Wietfeldt, Franksville, WI (US)

(73) Assignee: S.C. Johnson & Son, Inc., Racine, WI (US)

(21) Appl. No.: 15/529,254

(22) PCT Filed: Dec. 4, 2015
(86) PCT No.: PCT/US2015/063946

§ 371 Date: May 24, 2017

Related U.S. Application Data
(60) Provisional application No. 62/089,091, filed on Dec. 8, 2014.

(51) Int. Cl. C11C 5/00; A01N 25/34; A01N 25/08

(52) U.S. Cl. CPC C11C 5/002; A01N 25/08; A01N 25/34

(57) ABSTRACT

A volatile material delivery system which includes a wax warmer and one or more melt bodies positioned onto a reservoir of the wax warmer, are provided. When sufficient heat to liquefy at least a portion of a melt body is supplied to the reservoir, the system releases a volatile material into the surrounding air. Each melt body includes ionic liquid and at least one volatile material disposed within the melt body and may also include surfactant, dye, hardening agent, and/or stabilizer. A melt body package system, which includes at least two melt bodies and a container having discrete receptacles for holding each of the melt bodies within a separate receptacle is also provided.

### BACKGROUND

Candles have been used for centuries to provide illumination for the surrounding area. In more recent years, candles have been used as a fragrance and/or deodorizing mechanism for the home. A typical candle includes a wax body with a wick extending therethrough. When the wick is lit, the heat generated by the flame melts the wax body, which releases fragrance material entrained therein. Unfortunately, the use of candles with wicks may present a fire hazard and may additionally release an unpleasant smell of combustion into the fragrance profile.

In recent years, attempts have been made to provide a wickless candle that minimizes the fire hazard associated with candles, while at the same time provides the fragrance benefits associated therewith. Wickless candles are primarily composed of a base wax such as soy-based wax, paraffin, or a blend of both. Paraffin is a petroleum based wax used in most commercially sold candles. Soy-based wax is an all-natural wax derived from soy beans and is more environmentally friendly than paraffin.

Typical wickless candles may include an electric warmer and a wickless candle composition designed to be heated therein. The wickless candle compositions are typically either wax beads or wax bodies. The wax beads are usually provided in a container or bag that requires the consumer to tilt and/or pour the wax beads into the warmer. The wax bodies are usually provided in block form due to the manufacturing process utilized. After the fragrance or other volatiles has been depleted from the wax body it may be difficult to remove from the warmer.

### SUMMARY

The present disclosure relates generally to a melt delivery system for releasing volatile material, such as a fragrance and/or other volatile component. The melt delivery system typically includes a melt warmer and one or more melt bodies positioned on a heated receptacle, which is part of the warmer. The melt bodies commonly include ionic liquid having a melting point of at least about 35° C. and volatile material. The melt bodies may also include a surfactant, a dye, a hardening agent, and/or a stabilizer disposed therein.

In one aspect, the present melt bodies include ionic liquid and have a melting point of at least about 35° C. and, commonly, at least about 40° C. and include volatile material disposed within the melt body. The melt body may include at least about 50 wt. %, often, at least about 75 wt. % and, even, at least about 80 wt. % of the ionic liquid. The ionic liquid may include a deep eutectic solid. The volatile material may include a fragrance and/or volatile attractant, repellant, pesticide, essential oil, odor eliminator and/or sanitizer.

In many embodiments, the ionic liquid may be miscible with water. In many embodiments, the ionic liquid includes a deep eutectic solid that may be miscible with water.

In some embodiments, the deep eutectic solid may include an ionic compound formed from a hydrogen bond donor and a metal salt hydrate. For example, the ionic compound may be formed from calcium chloride dehydrate and urea, typically in a weight ratio of about 15:85 to 60:40, respectively, e.g., in a weight ratio of about 20:80, respectively. In other embodiments, the deep eutectic solid may include an ionic compound formed from a hydrogen bond donor and a metal salt. For example, the ionic compound may be formed from sodium bromide and urea, e.g., in a weight ratio of about 30:70, respectively.

The present disclosure also provides a method of delivering a volatile material, which includes placing at least one of the melt bodies onto the reservoir of a wax warmer; and applying sufficient heat to the reservoir to liquefy at least a portion of one or more melt bodies positioned onto the reservoir.

The present disclosure also provides a melt body package system, which includes two or more of the melt bodies positioned in a container having discrete receptacles for holding individual melt bodies therein, such that each of the melt bodies is held within a separate receptacle. The melt bodies commonly have opposing substantially planar surfaces.

### BRIEF DESCRIPTION OF THE DRAWINGS

FIG. 1 is an isometric view of a volatile material delivery system including a melt body warmer and a melt body according to an illustrative embodiment of the present disclosure.

FIG. 2 is an isometric view of a melt body package system with a plurality of melt bodies disposed within and adjacent to a container according to an embodiment of the present disclosure.

### DETAILED DESCRIPTION

The present disclosure provides melt bodies, which typically include a solid material which can be liquefied upon application of heat, thereby releasing volatile material disposed within the melt body. The melt bodies commonly have a melting point of at least about 35° C. and include ionic liquid as a base material which makes up a majority of the melt body. In many embodiments, the ionic liquid includes a deep eutectic solid. In some embodiments, the melt body has a melting point of at least about 40° C. Commonly, the melt body has a melting point of no more than about 150° C., more desirably no more than about 110° C. and often no more than about 100° C.

In some embodiments, the ionic liquid may have a melting point of about 35° C. to about 110° C. The ionic liquid typically has a melting point from about 35° C., from about 40° C., or even from about 50° C. to about 110° C., to about 100° C., or even to about 90° C.

In some embodiments, the melt body includes at least about 50 wt. % and, often, at least about 75 wt. % of the ionic liquid. In another embodiment, the melt body includes at least about 80 wt. %, at least about 85 wt. %, at least about 90 wt. %, or even at least about 95 wt. % of the ionic liquid.

In one embodiment, the ionic liquid may be miscible with water. In another embodiment, the deep eutectic solid may be miscible with water. The water miscibility of an ionic liquid and/or deep eutectic solid can be determined according to the following Ionic Liquid Water Miscibility Test:

A mixture of 0.5 g deep eutectic solid or other ionic liquid and 4.5 g de-ionized water are sonicated at 25° C. in a Bransonic Ultrasonic Bath (@ 50/60 Hz, 117 volts, 1.3 AMPS) for 1.5 hours. Thereafter, if a homogenous transparent system results within 15 minutes of standing at 25° C. without agitation, then the ionic liquid is determined to be water miscible. However, if the resulting mixture appears inhomogeneous after standing for 15 minutes without agitation, or appears translucent or exhibits separate phases/layers, the ionic liquid is determined to be water immiscible.

In some embodiments, the ionic liquid, which constitutes the base material of the melt bodies may include a deep eutectic solid. In many embodiments, the ionic liquid may include a substantial amount of the deep eutectic solid. For example, the ionic liquid may include at least about 90 wt. % of the deep eutectic solid. In certain embodiments, except for the presence of the volatile material and optionally other commonly used candle additive(s), the melt body may consist essentially of the deep eutectic solid. For example, the melt bodies may include at least about 50 wt. % and, often, at least about 75 wt. % of a deep eutectic solid and substantially all of the remaining components consist essentially of volatile materials and, optionally, one or more commonly used candle additive(s), such as a dye, surfactant and/or stabilizer.

As used herein the term “deep eutectic solid” refers to a type of ionic material composed of a mixture which forms a eutectic and has a melting point of at least about 35° C., and typically at least about 40° C. The deep eutectic solid typically has a melting point lower than that of either of the individual components. In some embodiments, the deep eutectic solid has a melting point of about 35° C. to about 120° C. In many instances, deep eutectic solids used herein may have a melting point of no more than about 110° C., no more than about 100° C., or even no more than about 90° C.

In many embodiments, the deep eutectic solid may be present in an amount of at least about 7 5 wt. %, at least about 85 wt. %, at least about 90 wt. %, or even at least about 95 wt. %. of the melt body. Preferably the melt body includes at least about 80 wt. % of the deep eutectic solid.

A number of different types of deep eutectic solids have been reported and may suitably be employed in forming the present melt bodies. Deep eutectic solids may be formed by reacting appropriate combinations of two of the following types of components: quaternary ammonium salts, metal salts, metal salt hydrates, and hydrogen bond donors. In such deep eutectic solids, the hydrogen bond donor may include an amide, e.g. an amide such as urea, thiourea, or acetamide; a carboxylic acid, such as oxalic acid, benzoic acid, malonic acid, or citric acid; an alcohol, such as benzyl alcohol or a sugar; an amine, such as aniline or hydroxylamine; and/or a substituted or unsubstituted phenol, such as vanillin or p-aminophenol. Exemplary suitable metal salts include the halide salts of zinc, iron, sodium or tin, such as ZnBr₂, FeCl₃, NaBr and SnCl₂. Exemplary suitable metal salt hydrates include hydrate of a chloride, nitrate, sulfate, or acetate salt of a Li, Mg, Ca, Cr, Mn, Fe, Co, Ni, Cu, Zn, Cd, Pb, Bi, La, or Ce cation.

For example, the following four types of deep eutectic solids have been reported and may suitably be used are formed in forming the present melt bodies. These types of deep eutectic solids may be formed by reacting the indicated types of compounds:

Type I: Quaternary ammonium salt+metal salt

Type II: Quaternary ammonium salt+metal salt hydrate

Type III: Quaternary ammonium salt+hydrogen bond donor

Type IV: Metal salt (hydrate)+hydrogen bond donor

In some embodiments, the quaternary ammonium salt may be a compound of Formula I:

R¹R²R³R⁴N+X⁻ Formula I

wherein
R¹, R², and R³ are each independently a hydrogen or C₁-C₅ alkyl group;
R⁴ is a C₁-C₁₀ alkyl or cycloalkyl group optionally substituted with at least one group selected from OH, Cl, Br, F, I, NH₂, CN, NO₂, C(O)OR⁵, OC(O)R⁵, COR⁵, CHO, and OR⁵;
wherein R⁵ is a hydrogen, C₁-C₁₀ alkyl or cycloalkyl group; and
X⁻ is NO₃⁻, F⁻, Cl⁻, Br⁻, I⁻, BF₄⁻, ClO₄⁻, CN⁻, SO₃CF₃⁻, or F₃CC(O)₂⁻.
   Typically, R1, R2, and R3 are each independently a C₁-C₅ alkyl group. Quite commonly, the quaternary ammonium salt may be choline chloride or acetylcholine chloride.

In some embodiments, the hydrogen bond donor is an organic compound capable of forming a hydrogen bond with X⁻. In some embodiments, the hydrogen bond donor is a compound of the formula R⁶CO₂H, R⁷R⁸NH, R⁹CZNH₂, or R¹⁰OH, wherein R⁶, R⁷, R⁸, and R¹⁰ are each independently a hydrogen, C₁-C₈ alkyl group optionally substituted with one or more groups selected from OH, SR⁵, Cl, Br, F, I, NH₂, CN, NO₂, OC(O)R⁵, COOR⁵, COR⁵, CHO, COR⁵, and OR⁵, wherein R⁵ is as defined above; R⁹ is a C₁-C₈ alkyl group optionally substituted with one or more groups selected from OH, SR⁵, Cl, Br, F, I, NH₂, CN, NO₂, OC(O)R⁵, COOR⁵, COR⁵, and OR⁵, wherein R⁵ is a hydrogen, C₁-C₁₀ alkyl or cycloalkyl group, or NHR¹¹, wherein R¹¹ is a hydrogen or C₁-C₆ alkyl group; and Z is O or S. Illustrative examples of suitable hydrogen bond donors include urea, acetamide, thiourea, glyoxylic acid, malonic acid, oxalic acid dehydrate, trifluoroacetic acid, benzoic acid, benzyl alcohol, p-methyl phenol, o-methyl phenol, m-methyl phenol, p-chloro phenol, D-fructose, and/or vanillin.

In some embodiments, the deep eutectic solid includes an ionic compound formed by the reaction of a quaternary ammonium salt and a metal salt (a Type I deep eutectic solid). Some examples of Type I deep eutectic solids may be prepared using the compounds in listed in Table 1 and by following the methods described in Abbott et al., Inorg. Chem., 3447 (2004).

TABLE 1

| N⁺R₁R₂R₃R₄Cl⁻ | | | | | |
|---|---|---|---|---|---|
| R₁ | R₂ | R₃ | R₄ | metal halide | Freezing point (° C.) |
| Me | Me | Me | C₂H₄OH | ZnBr₂ | 38 |
| Me | Me | Me | C₂H₄OH | FeCl₃ | 65 |
| Me | Me | Me | C₂H₄OH | SnCl₂ | 37 |
| Me | Me | Me | C₂H₄OC(O)Me | ZnBr₂ | 48 |
| Me | Me | Me | C₂H₄Cl | SnCl₂ | 63 |

In many embodiments, the deep eutectic solid includes an ionic compound formed by the reaction of a quaternary ammonium salt and a metal salt hydrate (a Type II deep eutectic solid). For example, Type II deep eutectic solids may be prepared using a quaternary ammonium salt, such as choline chloride, and a metal salt hydrate, such as ZnCl₂-2H₂O, CaCl₂-6H₂O, MgCl₂-6H₂O, CrCl₃-6H₂O, CoCl₂-6H₂O, LaCl₃-6H₂OCuCl₂-2H₂O, LiCl-5H₂O, Ca(NO₃)₂-4H₂O, Cr(NO₃)₃-9H₂O, Mn(NO₃)₂-4H₂O, Fe(NO₃)₃-9H₂O, Co(NO₃)₂-6H₂O, Ni(NO₃)₂-6H₂O, Cu(NO₃)₂-3H₂O, Li(NO₃)—H₂O, Mg(NO₃)₂-6H₂O, La(NO₃)₃-6H₂O, Cd(NO₃)₂.-4H₂O, Ce(NO₃)₃-6H₂O, Bi(NO₃)₃-5H₂O, Zn(NO₃)₂-4H₂O, Cd(OAc)₂-2H₂O, Pb(OAc)₂-3H₂O, SnCl₂-2H₂O or Cr₂(SO₄)₃-15H₂O. Other examples of suitable Type II deep eutectic solids are exemplified in U.S. Pat. No. 7,196,221.

In many embodiments, the deep eutectic solid may include an ionic compound formed by the reaction of a quaternary ammonium salt, and a hydrogen bond donor (a Type III deep eutectic solid). Examples of Type III deep eutectic solids may be prepared using a quaternary ammonium salt, such as choline chloride, and the hydrogen bond donors listed in Table 2 according to the methods described in international patent application no. PCT/GB01/04300. Table 2 lists the freezing points for a number of illustrative deep eutectic solids prepared from choline chloride and the corresponding hydrogen bond donor. Other suitable deep eutectic solids can be prepared from the quaternary ammonium salts represented by Formula I above and one or more of the hydrogen bond donors described herein.

TABLE 2

| Hydrogen bond donor | Freezing Point (° C.) |
|---|---|
| Acetamide, CH₃CONH₂ | 51 |
| Thiourea, NH₂CSNH₂ | 69 |
| Salicylamide, o-HOC₆H₄CONH₂ | 91 |
| Benzamide, C₆H₅CONH₂ | 92 |
| Oxalic acid, HOOCCOOH | 48 |
| Benzoic acid, C₆H₅COOH | 95 |
| Benzyl alcohol, C₆H₅CH₂OH | 61 |
| Vanilin, p-HO,m-CH₃OC₆H₃CHO | 42 |
| p-Aminophenol | 93 |
| Aniline | 44 |
| Hydroxylamine hydrochloride | 81 |

Type IV deep eutectic solids may be prepared using metal salts and/or their hydrates, such as a chloride, bromide, nitrate, sulfate, and acetate salt of a Li, Na, Mg, Ca, Cr, Mn, Fe, Co, Ni, Cu, Zn, Cd, Pb, Bi, La, or Ce cation. In some embodiments, the metal salt hydrate may suitably be a chloride, nitrate, sulfate, or acetate salt of a Li, Mg, Ca, or Zn cation. In some exemplary embodiment, the metal salt hydrate is calcium chloride dihydrate. In some embodiments, the metal salt may suitably be a Na⁺ or Zn⁺² salt, e.g., a halide salt such as a bromide salt of Na⁺ or Zn⁺². In some embodiments, the hydrogen bond donor may be at least one of an amide selected from the group consisting of urea, thiourea, and acetamide; a carboxylic acid selected from the group consisting of oxalic acid, benzoic acid, malonic acid, or citric acid; an alcohol; a substituted or unsubstituted phenol; or a sugar. In many embodiments, the hydrogen bond donor may be urea.

For example, the ionic compound formed by the reaction of calcium chloride dihydrate and urea in a weight percent ratio of about 20:80, respectively, exhibits a deep eutectic phenomenon. The resulting ionic compound has a melting point of about 85° C. (far less than the melting point of urea, 133° C., and the decomposition temperature of calcium chloride hydrate, 173° C.). The ionic compound formed from calcium chloride dihydrate and urea in a weight percent ratio of about 40:60, respectively, has a melting point of about 54-56° C. Other non-limiting examples include ionic compounds formed from the reaction of mixtures of a metal salt hydrate (e.g., a metal halide hydrate) with a hydrogen bond donor, such as urea, thiourea, malonic acid, or acetamide.

Although a melt body may include two or more deep eutectic solids, a single melt body typically only includes a single deep eutectic solid.

In some embodiments, the volatile material disposed within the melt body includes a fragrance, essential oil, pesticide, attractant, repellant, odor eliminator, and/or sanitizer.

In one embodiment, the volatile fragrance material may include may include one or more volatile fragrance materials selected from the group consisting of esters (e.g., butanoate esters and/or pentanoate esters), aldehydes, ionones, nitrites, ketones and combinations thereof.

In some embodiments, the volatile fragrance material may include one or more compounds selected from the group consisting of: 1-methylethyl-2-methylbutanoate; ethyl-2-methyl pentanoate; 1,5-dimethyl-1-ethenylhexyl-4-enyl acetate; p-menth-1-en-8-yl acetate; 4-(2,6,6-trimethyl-2-cyclohexenyl)-3-buten-2-one; 4-acetoxy-3-methoxy-1-propenylbenzene; 2-propenyl cyclohexanepropionate; bicyclo[2.2.1]hept-5-ene-2-carboxylic acid, 3-(1-methylethyl)-ethyl ester; bycyclo[2.2.1]heptan-2-ol, 1,7,7-trimethyl-, acetate 1,5-dimethyl-1-ethenylhex-4-enylacetate; hexyl 2-methyl propanoate; ethyl-2-methylbutanoate; 4-undecanone; 5-heptyldihydro-2(3h)-furanone; 1,6-nonadien-3-ol, 3,7dimethyl-; 3,7-dimethylocta-1,6-dien-3-o; 3-cyclohexene-1-carboxaldehyde, dimethyl-; 3,7-dimethyl-6-octene nitrile; 4-(2,6,6-trimethyl-1-cyclohexenyl)-3-buten-2-one; tridec-2-enonitrile; patchouli oil; ethyl tricycle[5.2.1.0]decan-2-carboxylate; 2,2-dimethyl-cyclohexanepropanol; hexyl ethanoate, 7-acetyl, 1,2,3,4,5,6,7,8-octahydro-1,1,6,7-tetramethyl naphtalene; allyl-cyclohexyloxy acetate; methyl nonyl acetic aldehyde; 1-spiro[4,5]dec-7-en-7-yl-4-pentenen-1-one; 7-octen-2-ol, 2-methyl-6-methylene-, dihydro; cyclohexanol, 2-(1,1-dimethylethyl)-, acetate; hexahydro-4,7-methanoinden-5(6)-yl propionatehexahydro-4,7-methanoinden-5(6)-yl propionate; 2-methoxynaphthalene; 1-(2,6,6-trimethyl-3-cyclohexenyl)-2-buten-1-one; 1-(2,6,6-trimethyl-2-cyclohexenyl)-2-buten-1-one; 3,7-dimethyloctan-3-ol; 3-buten-2-one, 3-methyl-4-(2,6,6-trimethyl-1-cyclohexen-2-yl)-; hexanoic acid, 2-propenyl ester; (z)-non-6-en-1-al; 1-decyl aldehyde; 1-octanal; 4-t-butyl-.alpha.-methylhydrocinnamaldehyde; alpha-hexylcinnamaldehyde; ethyl-2,4-hexadienoate; and 2-propenyl 3-cyclohexanepropanoate.

In some embodiments, the melt bodies are each designed to carry a volatile material that is to be dispersed as the melt body liquefies on the wax warmer, although it is contemplated that the melt body could be devoid of a volatile substance in some embodiments. It should be recognized that the volatile material, if present, is released from the melt body at a slow rate (e.g., under about 3 mg/hr) while the melt body is maintained as a solid at room temperature (about 23° C.). Once the melt body is exposed to a relatively low amount heat (e.g., an amount typical for a heater within a wax warmer), the melt body begins to liquefy and diffusion of the volatile material increases. Therefore, heating the melt body increases diffusion of the volatile material to provide a boost or spike of fragrance (or other volatile material) to the area surrounding the melt body.

In some embodiments, the melt body may include a volatile substance, which may be present in an amount of about 0.5 wt. % to about 20 wt. %, 1 wt. % to about 10 wt. %, or even about 2 wt. % to about 8 wt. %. The volatile substance present in the melt body may be that of a fragrance, essential oil, pesticide (e.g., insecticide), odor eliminator, attractant, repellant, deodorizer, and/or a cleaning substance (e.g., sanitizer), or the like. The volatile substance may also include actives, such as an air freshener, a mold or mildew inhibitor, an insect repellent, and/or the like, and/or have aromatherapeutic properties. The fragrance according to this disclosure may include one or more fragrant materials or materials that provide chemically active vapors. In one embodiment, the fragrance may include volatile, fragrant compounds including, but not limited to natural botanic extracts, essences, fragrance oils, and so forth. As is known in the art, many essential oils and other natural plant derivatives contain large percentages of highly volatile scents. In this regard, numerous essential oils, essences, and scented concentrates are commonly available from companies in the fragrance and food businesses.

In one embodiment, a volatile material may include a perfume raw material selected from the group consisting of perfume raw materials having a boiling point (B.P.) lower than about 250° C. and a ClogP lower than about 3, perfume raw materials having a B.P. of greater than about 250° C. and a ClogP of greater than about 3, perfume raw materials having a B.P. of greater than about 250° C. and a ClogP lower than about 3, perfume raw materials having a B.P. lower than about 250° C. and a ClogP greater than about 3, and mixtures thereof. Perfume raw materials having a boiling point B.P. lower than about 250° C. and a ClogP lower than about 3 are known as Quadrant I perfume raw materials, perfume raw materials having a B.P. of greater than about 250° C. and a ClogP of greater than about 3 are known as Quadrant IV perfume raw materials, perfume raw materials having a B.P. of greater than about 250° C. and a ClogP lower than about 3 are known as Quadrant II perfume raw materials, perfume raw materials having a B.P. lower than about 250° C. and a ClogP greater than about 3 are known as a Quadrant III perfume raw materials. In some embodiments, the perfume may include a perfume raw material having B.P. of lower than about 250° C. In another embodiment, the perfume may include a perfume raw material selected from the group consisting of Quadrant I, II, III perfume raw materials and mixtures thereof. In some embodiments, the perfume may include a Quadrant III perfume raw material. Example of suitable Quadrant I, II, III and IV perfume raw materials are disclosed in U.S. Pat. No. 6,869,923.

In some embodiments, the melt body may include two fragrances that may correspond to one or more portions of the melt body and/or one or more colors. For example, in one embodiment, the melt body may include a first color and a first fragrance associated therewith, and a second color and a second fragrance associated therewith. Numerous combinations are possible that embody the concept described herein. For example, in one embodiment, the first color may be maroon and correspond to a cinnamon fragrance, while the second color may be green and correspond to a pine tree fragrance. In another embodiment, the first color may be orange and correspond to a pumpkin pie fragrance, while the second color may be white and correspond to vanilla. In another embodiment, the first color may be light blue and correspond to fresh linen, while the second color may be light purple and correspond to lavender.

In another embodiment, the melt body may further include a surfactant, a dye, a hardening agent, and/or a stabilizer.

In some embodiments, the melt body compositions disclosed herein can include a surfactant, wherein the surfactant can be selected from nonionic and/or anionic and/or cationic surfactants and/or ampholytic and/or zwitterionic and/or semi-polar nonionic surfactants. The surfactant is typically present at a level of from about 0.1 wt. %, from about 1 wt. %, or even from about 3 wt. % of the composition to about 20 wt. %, to about 10 wt. %, or even to about 5 wt. % of the composition.

In some embodiments, hardening agents may be employed in the melt bodies. Hardening agents may often be referred to as solidification agents as they are responsible for maintaining the overall composition (which may include solids and liquids) in a solid form. In certain embodiments, the hardening agent may include a polyethylene glycol (PEG), EO/PO block copolymer, an amide or the like as are commonly employed for solidification agents. In a preferred embodiment the hardening agent comprises or consists of polyethylene glycol (PEG). Various solid polyethylene glycols suitable for use according to the invention are marketed under the trademarks Pluriol.™. (BASF) or Carbowax.™ (Dow Chemical). Beneficially, polyethylene glycols at lower molecular weights, such as PEG 4000, are biodegradable allowing a formulation to be environmentally safe and friendly.

The molecular weight of the polyethylene glycol may be less than about 8,000, and often may have a molecular weight of from about 4,000 (hereinafter PEG 4000) to about 8,000 (hereinafter PEG 8000). In many instances a biodegradable polyethylene glycol may be employed. An example of a preferred embodiment employs the PEG 4000, which forms solid block compositions having a good consistency. By “good consistency” it is meant that the solid retained a block shape without being overly brittle or liquefying after solidification. That is, the solid containing PEG 4000 did not crumble or break nor was it too fragile to handle or for shipment.

The amount of hardening agent included in the melt body may vary according to the type of volatile material disposed therein, the other components of the melt body, the intended use temperature, physical size of the solid compositions, the concentration of the other ingredients employed in the melt body, and other like factors. The amount of the hardening agent is effective to combine with the ionic liquid and other optional ingredients of the composition to form a homogeneous mixture under continuous mixing conditions.

In some embodiments, the melt body compositions disclosed herein can include a stabilizer and/or a dye, which are known in the art and available from commercial suppliers. In one embodiment, the stabilizer may be present in an amount of about 0.1 wt. % to about 1 wt. %, and in another embodiment may be present in an amount of less than about 1 wt. %. In one embodiment, the dye may be present in an amount of about 0.1 wt. % to about 1 wt. %, and in another embodiment may be present in an amount of less than about 1 wt. %.

Certain additives may be included in the present melt bodies to decrease the tendency of colorants, fragrance components and/or other components to migrate to an outer surface of the melt body. Such additives are referred to herein as “stabilizers.” One type of compounds which can act as a stabilizer are polymerized alpha olefins, more particularly polymerization products formed from alpha olefins having at least 10 carbon atoms and, more commonly, formed from one or more alpha olefins having 10 to about 25 carbon atoms. One suitable example of such as polymer is an alpha olefin polymer, such as sold under the trade name Vybar® 103 polymer (available from Baker-Petrolite, Sugarland, Tex.). The inclusion of sorbitan esters, such as sorbitan tristearate and/or sorbitan tripalmitate and related sorbitan triesters formed from mixtures of fully hydrogenated fatty acids, may also decrease the propensity of colorants, fragrance components and/or other components to migrate to the melt body surface. Other examples of suitable stabilizers include polyoxyethylene sorbitan fatty acid esters (often referred to as “polysorbates” or “polysorbate compounds”).

In some embodiments, the coloration from the dye may be used to convey different properties about the melt body to the consumer. For example, the color may be associated with a particular fragrance and/or volatile contained therein (e.g., burnt orange associated with pumpkin spice fragrance). The color of the melt body may be characterized by a substantially uniform single color such as red, orange, yellow, green, blue, purple, and/or other colors. In some embodiments, the melt body may be imparted with a single color, but small discolorations (e.g., specks, etc.) may be present within the melt body that are formed during the manufacturing process. In one embodiment, the melt body is a single color.

In another embodiment, the melt body may include two separate colors. In particular, at least a portion of the melt body above a longitudinal center axis is provided with a first color, whereas at least a portion of the melt body below the center axis is imparted with a second color. In a further embodiment, a pattern may be provided to a portion of the melt body. The pattern may be any shape and size. In one embodiment, the pattern may include swirls. The pattern may be characterized by at least two visually contrasting colors.

It is envisioned that numerous color and fragrance combinations are possible and are within the scope of this disclosure. Numerous variations of the melt body consistent with this disclosure including a melt body having a mottled appearance (i.e., uneven spots). In some embodiments, the melt body may include three layers that correspond to colors and/or fragrance patterns. In particular, it is contemplated that the layers disposed adjacent the top and bottom surfaces of the melt body may be substantially the same color and the layer disposed therebetween may be a different color. In a further embodiment, all three layers may be defined by a different color. In another embodiment, the colors may correspond to a different fragrance. In some embodiments, the melt body may have a tie dyed appearance. In some embodiments, the melt body may have two layers that are angled with respect to each other. The angled layers may correspond to a color that is different from the other. In some embodiments, the melt body may include a pattern. In some embodiments, the pattern may be embossed into the surface of the melt body. In another embodiment, the pattern may be applied to the surface of the melt body using ink or other coloration techniques. In some embodiments, the pattern may be embossed into the surface and/or protruding from the surface of the melt body. In another embodiment, the pattern may be embossed and/or imparted to the melt body during formation, or may be applied to the melt body during a separate step. In one embodiment, the embossed pattern may further be applied in a contrasting color to that of the underlying melt body for better visual clarity (e.g., using a color that is different from the melt body). In another embodiment, the embossed pattern may be applied to the melt body and not imparted with a different color.

In some embodiments, the melt body may include different combinations of fragrances to enhance the user's experience during melting. For example, in a melt body that includes three layers, one layer (e.g., the middle layer) may include a separate fragrance and/or additive that provides a boost of fragrance to the user before the next layer of the melt body liquefies. This boost may be accomplished using a fragrance additive, using a fragrance that is different from the fragrance disposed in other layers of the melt body, and/or providing the fragrance in a higher concentration than that of the surrounding layer(s).

In some embodiments, the fragrance combination used in the melt body is designed to provide a user experience that is associated with a holiday, a feeling, a season, and/or other experiences. For example, a melt body may impart the experience and/or feeling of a holiday meal or flavors. In particular, the combination of pumpkin, vanilla, and coffee may be used to invoke a fall fragrancing experience. Some embodiments may include a clean linen fragrance associated with a white layer, a dark blue layer imparted with a higher intensity clean soapy fragrance, and a light yellow layer with a light citrus fragrance to invoke a sunny day. Another embodiment may include a cocoa fragrance associated with a brown layer, a peppermint fragrance associated with a pink or red layer, and a marshmallow fragrance associated with a white layer. Other embodiments include a fragrance and/or color combinations that include a soapy fragrance provided in a dark blue color layer in combination with a lavender fragrance provided in a lavender color layer. In another embodiment, the melt body may include an apple cinnamon fragrance provided in a dark red or maroon layer in combination with a vanilla fragrance provided in a white or off-white layer. In a further embodiment, the melt body may include one or more floral fragrances such as a rose fragrance provided in a light yellow layer in combination with a lavender peach blossom fragrance provided in a purple layer. In still another embodiment, the melt body may include a woody fragrance (e.g., Cashmere woods) provided in a brown layer in combination with a vanilla fragrance provided in a white or off-white layer. It should be noted that the specific colors associated with each of the fragrances are examples and that other fragrance/color combinations may be used.

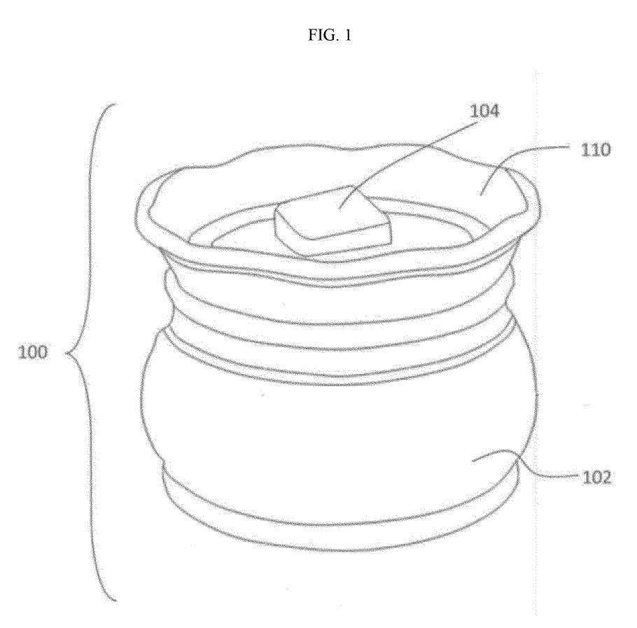

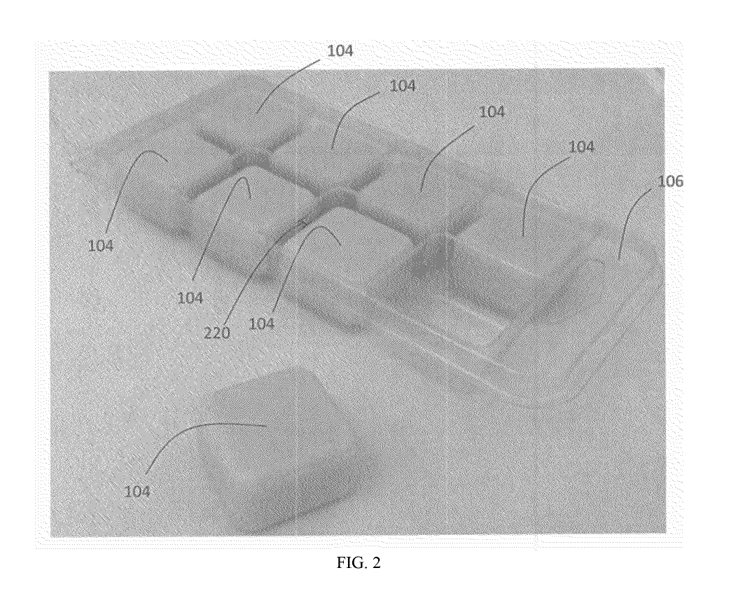

The present disclosure also provides a volatile material delivery system including a wax warmer having a reservoir and at least one melt body, as disclosed herein, positioned onto the reservoir. With reference to FIGS. 1 and 2, one particular embodiment of a melt body warmer system 100 is illustrated and generally includes a wax warmer designed to accommodate one or more melt bodies 104 and thereby release at least one volatile material disposed therein into the surrounding environment. The melt body warmer system 100 generally includes a body 102, a reservoir 110, and a heater assembly (not shown). The body 102 is fashioned to house the heater assembly and provide a support structure for the reservoir 110. The reservoir 110 is designed to accommodate one or more melt bodies 104. The melt body warmer system 100 includes a power source (not shown) that is provided in the form of an electrical power cord, a battery, a tealight, and/or another power source that provides energy thereto. The melt body warmer system 100 may be characterized by any structure that provides a surface in a warmer reservoir designed to transfer heat from the warmer to the melt body 104. One suitable melt body warmer system 100 is a wax warmer disclosed in U.S. patent application Ser. No. 14/136,201, filed on Dec. 20, 2013, hereby incorporated by reference in its entirety. The melt body warmer system 100 is generally described to include the aforementioned components, but may be adapted to add or remove various components according to specific user requirements. When the melt body 104 is placed into the receptacle 106, a gap 220 (see FIG. 2) is formed around the perimeter thereof between the sidewalls 122a-122d of the melt body 104 and the sidewalls 212 of the receptacle 202.

In other aspects, a melt body package system is provided. The package system includes at least two melt bodies as disclosed herein, each melt body having opposing substantially planar surfaces; and a container having discrete receptacles for holding each of at least two melt bodies therein, wherein each of the at least two melt bodies is held within a separate receptacle.

In an illustrative embodiment, the melt bodies 104 are provided in a receptacle 106 having particularly suitable characteristics with respect to storing, retaining, and removing the melt bodies 104 (see FIG. 2). When the melt body 104 is placed into the receptacle 106, a gap 220 may be formed around the perimeter thereof between the sidewalls of the melt body 104 and the sidewalls of the receptacle 202. One or more components of the melt body warmer system 100 may be sold separately or as part of a kit. The kit may include any of the components described herein and may further include instructions for use of the melt body warmer system 100. It is envisioned that the warmer system 100 described herein includes at least one melt body 104 that is devoid of a wick (e.g., wickless). Additionally, it is envisioned that the melting process of the melt body 104 is accomplished via means that does not include a flame directly adjacent thereto. For example, in one embodiment, heat is applied to the melt body 104 using a heater. In another embodiment, heat provided from a flame may be applied to the melt body 104, but in this instance the flame does not contact the melt body 104 directly and may be present within the warmer.

In some embodiments, the melt bodies may be designed to emit one or more volatile materials or otherwise liquefy for a specific time period to provide the user with certainty about the longevity of the release of the volatile material. For example, in one embodiment, a single melt body may liquefy completely in the reservoir with heat applied to the melt body by the heater of the warmer system at a temperature of about 60-90° C. (commonly about 75° C. after a time period of between about 30 minutes to about 80 minutes using the warmer system disposed in a room having an ambient temperature of about 20-25° C. In another embodiment, a single melt body may liquefy completely over a time period of about 60 minutes using the warmer system with heat applied to the melt body by the heater of the warmer system at a temperature of about 60-90° C. disposed in a room at about 20-25° C. In a further embodiment, a single melt body 104 liquefies completely with heat applied to the melt body 104 by the heater of the warmer system 102 at a temperature of about 60-90° C. over a time period of between about 50 minutes to about 70 minutes using the warmer system disclosed herein disposed in a room at about 20-25° C. In still a further embodiment, a single melt body liquefies completely with heat applied to the melt body 104 by the heater of the warmer system at a temperature of about 60-90° C. over a time period of greater than about 30 minutes using the melt body system disclosed herein disposed in a room at about 20-25° C.

The melt bodies may further be designed to liquefy at a specified temperature that is related to the heating capabilities of the warmer system. For example, the melt bodies may each be designed to melt at a temperature of between 40° C. to about 90° C. In another embodiment, the melt bodies may be designed to melt at a temperature of between about 50° C. to about 85° C. The melting and/or physical properties of the melt bodies may provide specific diffusion capabilities according to the strength of the warmer system, but also may provide stability such that the melt body does not liquefy while being transported and/or are being handled prior to use.

In one particular embodiment, the ionic liquid is present in an amount of about 91.5 wt. %, the fragrance is present in an amount of about 6.5 wt. %, the stabilizer is present in an amount of about 1 wt. %, and the dye is present in an amount of about 1 wt. %. In another embodiment, the ionic liquid is present in an amount of about 93 wt. %, the fragrance is present in an amount of about 6.5 wt. %, the stabilizer is present in an amount of about 0.3 wt. %, and the dye is present in an amount of up to about 0.4 wt. %.

In some embodiments, the melt body includes at least about 80 wt. % of the deep eutectic solid and about 0.1 wt. % to about 10 wt. % of a fragrance. In one embodiment, the melt body further includes up to about 1.0 wt. % of a dye and/or up to about 20 wt. % of a surfactant.

In another embodiment, the melt body includes at least about 80 wt. % of the deep eutectic solid; about 0.1 wt. % to about 20 wt. %, more commonly about 10 wt. % of a volatile insecticide and/or volatile attractant; and up to about 0.5 wt. % of a dye.

To properly fit into a typical warmer reservoir and to ensure proper melting characteristics, the melt bodies are preferably shaped to a specific dimension that corresponds with the dimensions of the reservoir. In one embodiment, each melt body includes a height dimension as measured along the sidewall from the upper surface to the lower surface. In one embodiment, the height dimension is between about 10 mm to about 30 mm, and in another embodiment is between about 15 mm to about 20 mm. In another embodiment, the height dimension is about 18 mm. In a further embodiment the height dimension is greater than about 12 mm and less than about 24 mm.

Each melt body includes a length dimension as measured along the upper or lower surface between opposing sidewalls. In one embodiment, the length dimension is between about 20 mm to about 40 mm, and in another embodiment is between about 25 mm to about 35 mm. In another embodiment, the length dimension is about 30 mm. In a further embodiment the length dimension is greater than about 26 mm and less than about 32 mm. Additionally, each melt body 104 includes a width dimension as measured along the upper or lower surface between opposing sidewalls. In one embodiment, the width dimension is between about 20 mm to about 40 mm, and in another embodiment is between about 25 mm to about 35 mm. In another embodiment, the width dimension is about 30 mm. In a further embodiment the width dimension is substantially the same as the length dimension.

Each melt body is also defined by the weight thereof. In particular, each melt body is sized with respect to the reservoir to emit a volatile for a specific pre-defined time period. To accomplish this emission, each melt body commonly weighs between about 0.005 kg to 0.1 kg. In many embodiments, each melt body may weigh from about 0.01 kg to 0.03 kg. Quite commonly each melt body weighs about 0.1 kg to 0.03 kg.

A method of providing one or more of the components of the kit including the melt bodies, container, and/or melt body warmer system is contemplated. For example, the melt bodies may be provided in a container with or without the melt body warmer system. Once a consumer purchases the melt body warmer system, the system is removed from the packaging and the heater is turned on (e.g., via plug, battery, tea light, and the like). The lid of the container may be opened and the consumer is able to select a melt body. The melt body may be grasped and removed from the container by placing one or more fingers in the space between the melt body and the receptacle. In another embodiment, the container may be tilted or otherwise rotated until a melt body slides out of the receptacle. In a further embodiment, the container may be imparted with divots or other curvature to allow a user to more easily insert a finger into the receptacle to grasp the melt body.

At this point, the melt body is placed on the reservoir of the melt body warmer system with either the upper surface or the lower surface of the melt body contacting the surface of the reservoir. The melt body is designed to be centrally disposed and spaced away from (i.e., does not touch) the raised edge that circumscribes the reservoir. As the temperature of the reservoir is increased, the melt body begins to liquefy and the volatile material is released therefrom. As the melt body liquefies, the diffusion of the volatile material may increase to greater than about 3 mg/hr.

In another embodiment, the container is provided with one or more melt bodies having two fragrances or more that correspond to two or more colors, where the first color is associated with a first fragrance and the second color is associated with a second fragrance). After removing the melt body from the packaging, the consumer is able to decide which fragrance will be emitted first of the two outer fragrances (if more than one fragrance is imparted to the melt body). For example, the consumer may choose to place the melt body into the reservoir of the warmer system with the second color disposed adjacent the surface of the reservoir. The second fragrance is released at a higher rate than the first fragrance until the melt body liquefies enough such that the first color portion of the melt body is adjacent to the liquefied melt body or the reservoir. Once the first color portion of the melt body is adjacent to the surface of the reservoir, the diffusion rate of the first fragrance increases. In this way, the consumer is able to control which scent is to be released first and/or the intensity profile of the two fragrances over a period of time.

It is envisioned that any of the melt bodies disclosed herein may be used in any of the containers disclosed herein. It is further envisioned that the containers may include any number of reservoirs suitable to hold the melt bodies. In some embodiments, a first melt body having a profile defined by one or more specific color(s), fragrance(s), number of layer(s), inclusion of other volatiles, and/or any other characteristics described herein may be provided in a container with a different melt body having a second, different profile. The profile may be defined by any of the characteristics described herein. The second melt body may differ from the first melt body in any number of respects. For example, the second melt body may be different from the first melt body in that at least one of the color(s), fragrance(s), number of layer(s), and/or volatiles is different from that of the first melt body. In a further embodiment, a third melt body having a different profile from that of the first and second melt body is provided in the same container. A fourth, fifth, and sixth melt body, each one having a different profile of that of the first, second, and third melt body profiles (and each other) may also be provided in a single container. It is envisioned that any number of melt bodies may be provided in a single container having the same profile, different profiles, and/or combinations thereof.

### Examples

The following examples more specifically illustrate protocols for preparing polymers according to various embodiments described above. These examples should in no way be construed as limiting the scope of the present technology.

### Example 1

A deep eutectic solid according to the present technology can be produced as follows. A mixture of 20 g of calcium chloride dihydrate and 80 g of urea is heated to a temperature of about 100° C. to about 120° C. for a period of about 30 minutes and then is allowed to cool to room temperature. The product is a solid at room temperature and has a melting point of about 85° C.

### Example 2

A scented melt body according to the present technology can be produced as follows. About 80 g to about 99 g of the deep eutectic solid of Example 1, about 0.1 g to about 10 g of a volatile fragrance material, optionally about 0.1 g to about 1 g of a dye, and optionally about 0 g to about 20 g of a surfactant are combined by heating the deep eutectic solid sufficiently to liquefy the material and then adding the other components. After cooling, the resulting product is a solid at room temperature. If desired, while the mixture is still in liquefied state it may be poured into a mold having a desired shape before being allowed to cool to room temperature.

### Example 3

A cleaner concentrate melt body according to the present technology can be produced as follows. About 80 g to about 99 g of the deep eutectic solid of Example 1, about 0.1 g to about 10 g of a volatile fragrance material, about 0.1 g to about 20 g of a surfactant (e.g., Genapol T250), and optionally about 0.1 g to about 1 g of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 4

An insecticide melt body according to the present technology can be produced as follows. About 80 g to about 99 g of the deep eutectic solid of Example 1, about 0.1 g to about 20 g of a volatile insect attractant and/or insecticide (e.g., an insecticide such as transfluthrin), and optionally about 0.1 g to about 1 g of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 5

A melt body according to the present technology can be produced as follows. A deep eutectic solid is formed by heating a mixture of a 2:1 molar ratio of copper (II) chloride dihydrate and choline chloride to a temperature of about 100° C. to about 120° C. for a period of about 20-30 minutes. The resulting deep eutectic solid is a solid at room temperature and has a freezing point of about 50° C. A melt body may be formed by combining about 90 g. this deep eutectic solid, about 7 g. of a volatile fragrance material, and about 3 g. of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 6

A melt body according to the present technology can be produced as follows. A mixture of a 2:1 molar ratio of lithium chloride pentahydrate and choline chloride may be heated to a temperature of about 100 to 120° C. for a period of about 20-30 minutes. After cooling, the product is a solid at room temperature and has a freezing point of about 50° C. A melt body may be formed by combining about 99 g. this deep eutectic solid with about 1 g. of a volatile insect repellant, such as metofluthrin, are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 7

A melt body according to the present technology can be produced as follows. A mixture of a 2:1 molar ratio of oxalic acid and choline chloride may be heated to a temperature of about 60-80° C. for a period of about 20-30 minutes. After cooling, the product is a solid at room temperature and has a freezing point of about 50° C. A melt body may be formed by combining about 99 g. this deep eutectic solid with about 1 g. of a volatile insect repellant, such as volatile fragrance material, are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 8

A melt body according to the present technology can be produced as follows. A mixture of a 2:1 molar ratio of zinc bromide and acetylcholine chloride may be heated to a temperature of about 100 to 120° C. for a period of about 20-30 minutes. After cooling, the product is a solid at room temperature and has a freezing point of about 50° C. A melt body may be formed by combining about 99 g. this deep eutectic solid with about 1 g. of a volatile insect attractant (e.g., 1-octen-3-ol), are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 9

A ionic liquid according to the present technology can be produced as follows. A mixture of 30.5 g sodium bromide and 69.5 g urea is heated to a temperature of about 100° C. to about 120° C. for a period of about 30 minutes and then is allowed to cool to room temperature. The product is a solid at room temperature and has a melting point of about 64-66° C.

### Example 10

A scented melt body according to the present technology can be produced as follows. About 80 g to about 99 g of the deep eutectic solid of Example 9, about 0.1 g to about 10 g of a volatile fragrance material, optionally about 0.1 g to about 1 g of a dye, and optionally about 0 g to about 20 g of a surfactant are combined by heating the deep eutectic solid sufficiently to liquefy the material and then adding the other components. After cooling, the resulting product is a solid at room temperature. If desired, while the mixture is still in liquefied state it may be poured into a mold having a desired shape before being allowed to cool to room temperature.

### Example 11

A cleaner concentrate melt body according to the present technology can be produced as follows. About 80 g to about 99 g of the deep eutectic solid of Example 9, about 0.1 g to about 20 g of a surfactant (e.g., an ethoxylated alcohol nonionic surfactant, such as Genapol T250), and optionally about 0.1 g to about 10 g of a volatile fragrance material and/or about 0.1 g to about 1 g of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 12

An insecticide melt body according to the present technology can be produced as follows. About 80 g to about 99 g of the deep eutectic solid of Example 9, about 0.1 g to about 20 g of a volatile insect attractant and/or insecticide (e.g., an insecticide such as transfluthrin), and optionally about 0.1 g to about 1 g of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

### Example 13

A deep eutectic solid according to the present technology can be produced as follows. A mixture of 40 g of calcium chloride dihydrate and 60 g of urea is heated to a temperature of about 100° C. to about 120° C. for a period of about 30 minutes and then is allowed to cool to room temperature. The product is a solid at room temperature and has a melting point of about 54-56° C.

### Example 14

A cleaner concentrate melt body according to the present technology can be produced as follows. About 80 g to about 99 g of the deep eutectic solid of Example 13, about 0.1 g to about 10 g of a volatile fragrance material, about 0.1 g to about 20 g of a surfactant (e.g., Genapol T250), and optionally about 0.1 g to about 1 g of a dye are combined by heating the deep eutectic solid sufficiently heated to liquefy the material and then adding the other components. After cooling, the resulting product is a solid at room temperature. If desired, while the mixture is still in liquefied state it may be poured into a mold having a desired shape before being allowed to cool to room temperature.

The present disclosure is not to be limited in terms of the particular embodiments described in this application. Many modifications and variations can be made without departing from its spirit and scope, as will be apparent to those skilled in the art.

### Illustrative Embodiments

A volatile material delivery system, which includes a wax warmer and one or more melt bodies positioned onto a reservoir of the wax warmer, is provided herein. When sufficient heat to liquefy at least a portion of a melt body is supplied to the reservoir, the system releases a volatile material into the surrounding air. Each melt body includes ionic liquid and at least one volatile material disposed within the melt body and may also include surfactant, dye, hardening agent, and/or stabilizer. The ionic liquid may desirably be miscible with water. The volatile material may suitably comprise a fragrance, essential oil, pesticide, attractant, repellant, odor eliminator, and/or sanitizer. Each melt body typically has a melting point of at least about 35° C. and no more than about 110° C.

A melt body package system, which includes at least two melt bodies and a container having discrete receptacles for holding each of the melt bodies within a separate receptacle is also provided.

The melt bodies commonly have a melting point of at least about 35° C. Typically, each melt body comprises at least about 50 wt. % and, often, at least about 75 wt. % and commonly, at least about 80 wt. % of the ionic liquid. The ionic liquid may have a melting point of about 35° C. to about 110° C. The ionic liquid may comprise a deep eutectic solid, which may make up at least about 75 wt. % and, often, at least about 80 wt. % of the melt body.

The deep eutectic solid has a melting point of at least about 35° C. and in many instances at least about 40° C. Commonly, the deep eutectic solid has a melting point of no more than about 100° C. The deep eutectic solid may desirably be miscible with water. In some embodiments, the deep eutectic solid comprises an ionic compound formed by the reaction of a hydrogen bond donor and a metal salt hydrate. For example, the deep eutectic solid may comprise an ionic compound formed by the reaction where the hydrogen bond donor is urea and the metal salt hydrate is calcium chloride dihydrate. An exemplary ionic compound may be formed by the reaction of calcium chloride dihydrate and urea in a weight ratio of about 20:80.

In some embodiments, the deep eutectic solid comprises an ionic compound formed by the reaction of a quaternary ammonium salt and a hydrogen bond donor. In other embodiments, the deep eutectic solid comprises an ionic compound formed by the reaction of a quaternary ammonium salt and a metal salt. In still other embodiments, the deep eutectic solid comprises an ionic compound formed by the reaction of a quaternary ammonium salt and a metal salt hydrate. In these embodiments, choline chloride may suitably be used as the quaternary ammonium salt. Examples of suitable metal salt hydrates include a chloride, nitrate, sulfate, or acetate salt of a Li, Mg, Ca, Cr, Mn, Fe, Co, Ni, Cu, Zn, Cd, Pb, Bi, La, or Ce cation. In many embodiments, the metal salt hydrate is a chloride, nitrate, sulfate, or acetate salt of a Li, Mg, Ca, or Zn cation. Examples of suitable hydrogen bond donors include amides selected from the group consisting of urea, thiourea, and acetamide; carboxylic acids selected from the group consisting of oxalic acid, benzoic acid, malonic acid, or citric acid; alcohols; and substituted or unsubstituted phenols.

In some embodiments, each melt body comprises at least about 80 wt. % of a deep eutectic solid and about 0.1 wt. % to 10 wt. % of a volatile fragrance. Each melt body may comprise up to about 1.0 wt. % of a dye and/or up to about 20 wt. %, more commonly up to about 10 wt. % of a surfactant and/or stabilizer.

In some embodiments, each melt body comprises at least about 80 wt. % of a deep eutectic solid; about 0.1 wt. % to about 20 wt. % of a volatile insecticide and/or volatile attractant; and optionally up to about 0.5 wt. % of a dye.

In many embodiments, each melt body comprises an ionic compound formed from a hydrogen bond donor and a metal salt hydrate, such as an ionic compound formed from urea and calcium chloride dihydrate. For example, the ionic compound may be a deep eutectic solid formed from calcium chloride dihydrate and urea in a weight ratio of about 20:80. In other instances, the ionic compound may be a deep eutectic solid formed from calcium chloride dihydrate and urea in a weight ratio of about 40:60.

In many embodiments, each melt body comprises an ionic compound formed from a hydrogen bond donor and a metal salt, such as an ionic compound formed from urea and sodium bromide. For example, the ionic compound may be a deep eutectic solid formed from sodium bromide and urea in a weight ratio of about 30:70.

In some embodiments, the melt bodies comprise an ionic liquid which includes an ionic compound formed from quaternary ammonium salt and a halide salt of a Na, Fe, Zn, or Sn cation.

In some embodiments, the melt bodies comprise an ionic liquid which includes an ionic compound formed from a mixture which includes a quaternary ammonium salt and a hydrogen bond donor.

In some embodiments, the melt bodies comprise an ionic liquid which includes an ionic compound formed from a mixture which includes a an ionic compound formed from a quaternary ammonium salt and a metal salt.

In some embodiments, the melt bodies comprise an ionic liquid which includes an ionic compound formed from a mixture which includes a quaternary ammonium salt and a metal salt hydrate.

In some embodiments, the melt bodies comprise an ionic liquid which includes an ionic compound formed from a mixture which includes a hydrogen bond donor and a metal salt or a hydrate thereof.

While certain embodiments have been illustrated and described, it should be understood that changes and modifications can be made therein in accordance with ordinary skill in the art without departing from the technology in its broader aspects.

The embodiments, illustratively described herein may suitably be practiced in the absence of any element or elements, limitation or limitations, not specifically disclosed herein. Thus, for example, the terms “comprising,” “including,” “containing,” shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof.

1. A melt body having a melting point of at least about 35° C., wherein the melt body comprises an ionic liquid and at least one volatile material disposed within the melt body.

2. The melt body of claim 1, wherein the melt body comprises at least about 50 wt. % of the ionic liquid.

3. The melt body of claim 1, wherein the ionic liquid comprises a deep eutectic solid.

4. The melt body of claim 3, wherein the melt body comprises at least about 75 wt. % of the deep eutectic solid.

5. The melt body of claim 1, wherein the ionic liquid comprises an ionic compound formed from a hydrogen bond donor and a metal salt hydrate.

6. The melt body of claim 5, wherein the hydrogen bond donor is urea.

7. The melt body of claim 6, wherein the metal salt hydrate is calcium chloride dihydrate.

8. The melt body of claim 7, wherein the ionic compound is formed from calcium chloride dihydrate and urea in a weight ratio of about 15:85 to 60:40.

9. The melt body of claim 7, wherein the ionic compound is formed from calcium chloride dihydrate and urea in a weight ratio of about 20:80.

10. The melt body of claim 7, wherein the ionic compound is formed from calcium chloride dihydrate and urea in a weight ratio of about 40:60.

11. The melt body of claim 1, wherein the ionic liquid comprises an ionic compound formed from a quaternary ammonium salt and a hydrogen bond donor.

12. The melt body of claim 1, or wherein the ionic liquid comprises an ionic compound formed from a quaternary ammonium salt and a metal salt.

13. The melt body of claim 1, wherein the ionic liquid comprises an ionic compound formed from a quaternary ammonium salt and a metal salt hydrate.

14. The melt body of claim 13, wherein the quaternary ammonium salt is choline chloride.

15. The melt body of claim 1, or wherein the ionic liquid comprises an ionic compound formed from a hydrogen bond donor and a metal salt.

16. The melt body of claim 15, wherein the hydrogen bond donor is urea.

17. The melt body of claim 16, wherein the metal salt is sodium bromide.

18. The melt body of claim 15, wherein the ionic compound is formed from sodium bromide and urea.

19. The melt body of claim 15, wherein the ionic compound is formed from sodium bromide and urea in a weight ratio of about 30:70.

20. The melt body of claim 5, wherein the ionic compound is formed from calcium chloride dihydrate and urea.

21. The melt body of claim 1, wherein the melt body further comprises a surfactant, a dye, a hardening agent, and/or a stabilizer.

22. The melt body of claim 1, wherein the volatile material comprises a fragrance, essential oil, pesticide, attractant, repellant, odor eliminator, and/or sanitizer.

23. The melt body of claim 3, wherein the melt body comprises at least about 80 wt. % of the ionic liquid and about 0.1 wt. % to about 10 wt. % of a fragrance.

24. The melt body of claim 3, wherein the melt body further comprises up to about 1.0 wt. % of a dye and/or up to about 20 wt. % of a surfactant.

25. The melt body of claim 3, wherein the melt body comprises at least about 80 wt. % of the ionic liquid; about 0.1 wt. % to about 20 wt. % of a volatile insecticide and/or volatile attractant; and up to about 0.1 wt. % of a dye.

26. The melt body of claim 1, wherein the melt body has a melting point of no more than about 140° C.

27. The melt body of claim 1, wherein the melt body has a melting point of no more than about 110° C.

28. The melt body of claim 1, wherein the ionic liquid has a melting point of about 35° C. to about 90° C.

29. The melt body of claim 3, wherein the deep eutectic solid has a melting point of about 35° C. to about 100° C.

30. The melt body of claim 5, wherein the metal salt hydrate is a chloride, nitrate, sulfate, or acetate salt of a Li, Mg, Ca, Cr, Mn, Fe, Co, Ni, Cu, Zn, Cd, Pb, Bi, La, or Ce cation.

31. The melt body of claim 5, wherein the metal salt hydrate is a chloride, nitrate, sulfate, or acetate salt of a Li, Mg, Ca, or Zn cation.

32. The melt body of claim 5, wherein the hydrogen bond donor comprises at least one of:
an amide selected from the group consisting of urea, thiourea, and acetamide;
a carboxylic acid selected from the group consisting of oxalic acid, benzoic acid, malonic acid, or citric acid;
an alcohol; and
a substituted or unsubstituted phenol.

33. The melt body of claim 10, wherein the metal salt is zinc bromide or sodium bromide.

34. The melt body of claim 1, wherein the ionic liquid is miscible with water.

35. The melt body of claim 3, wherein the deep eutectic solid is miscible with water.

36. A volatile material delivery system comprising:
a wax warmer having a reservoir; and
at least one melt body according to claim 1 positioned onto the reservoir.

37. A method of delivering a volatile material comprising:
placing at least one melt body according to claim 1 onto a reservoir of a wax warmer; and
applying heat to the reservoir sufficient to liquefy at least a portion of at least one melt body positioned onto the reservoir.

38. A melt body package system comprising at least two melt bodies according to claim 1; and a container having discrete receptacles for holding each of at least two melt bodies therein, wherein each of the at least two melt bodies is held within a separate receptacle.

39. The melt body package system of claim 38, wherein each melt body has opposing substantially planar surfaces.

40. The melt body of claim 1, wherein the ionic liquid comprises an ionic compound formed from a mixture which includes a hydrogen bond donor selected from the group consisting of an amide, a carboxylic acid, an alcohol, an amine, and/or a phenol.

41. The melt body of claim 1, wherein the ionic liquid comprises an ionic compound formed from zinc bromide and acetylcholine chloride.

42. The melt body of claim 1, wherein the ionic liquid comprises an ionic compound formed from copper (II) chloride dihydrate and choline chloride

43. The melt body of claim 1, wherein the ionic liquid comprises an ionic compound formed from oxalic acid and choline chloride.

44. The melt body of claim 1, wherein the ionic liquid comprises an ionic compound formed from lithium chloride pentahydrate and choline chloride.

45. The melt body of claim 1, wherein the ionic liquid comprises an ionic compound formed from quaternary ammonium salt and a halide salt of a Na, Fe, Zn, or Sn cation.

46. The melt body of claim 1, wherein the ionic liquid comprises an ionic compound formed from a mixture which includes a quaternary ammonium salt and a hydrogen bond donor.

47. The melt body of claim 1, wherein the ionic liquid comprises an ionic compound formed from a mixture which includes a an ionic compound formed from a quaternary ammonium salt and a metal salt.

48. The melt body of claim 1, wherein the ionic liquid comprises an ionic compound formed from a mixture which includes a quaternary ammonium salt and a metal salt hydrate.

49. The melt body of claim 1, wherein the ionic liquid comprises an ionic compound formed from a mixture which includes a hydrogen bond donor and a metal salt or a hydrate thereof.
